(19) United States
(12) Patent Application Publication
(10) Pub. No.: US 2025/0277370 A1
(43) Pub. Date: Sep. 4, 2025

(54) DEVICE FOR SECURING ROOFING MATERIAL TO A ROOFING SUBSTRATE OR AN UNDERLYING ROOFING MATERIAL AND METHODS OF USING THE SAME

(71) Applicant: BMIC LLC, Dallas, TX (US)

(72) Inventors: Ashley Alfonso, Fanwood, NJ (US); Ming-Liang Shiao, Collegeville, PA (US); Luis Duque, Hackensack, NJ (US); Brian Lee, Cranford, NJ (US)

(21) Appl. No.: 19/064,967

(22) Filed: Feb. 27, 2025

Related U.S. Application Data
(60) Provisional application No. 63/559,307, filed on Feb. 29, 2024.

(51) Int. Cl. E04D 15/02; B05C 17/005; B25C 1/00

(52) U.S. Cl. CPC E04D 15/02; B05C 17/00523; B05C 17/00596; B25C 1/003

(57) ABSTRACT

A method includes obtaining a first roofing material and a second roofing material and obtaining a device. The device includes a fastening mechanism to secure a roofing material to a roofing substrate and/or an underlying roofing material and an adhesive mechanism to apply an adhesive to a surface of the roofing material. The fastening mechanism includes a frame, a magazine of fasteners, and a trigger. The adhesive mechanism includes a container having a nozzle, wherein the container houses the adhesive and the nozzle dispenses the adhesive. The method includes positioning the first roofing material onto the roofing substrate and/or the underlying roofing material, securing the first roofing material to the roofing substrate and/or the underlying roofing material with the fastening mechanism, dispensing the adhesive from the adhesive mechanism onto the surface of the first roofing material, and contacting the second roofing material and the first roofing material such that the adhesive is between the second roofing material and the first roofing material.

This application claims the priority of U.S. provisional application Ser. No. U.S. 63/559,307 entitled “Device for Securing Roofing Material to a Roofing Substrate and Method of Using the Same” filed Feb. 29, 2024, which is incorporated herein by reference in its entirety for all purposes.

### FIELD OF THE INVENTION

This invention relates to a device for fastening and/or adhering roofing material to a roofing substrate and/or an additional roofing material(s). This invention further relates to a method for securing the roofing material to the roofing substrate and/or additional roofing material(s).

### BACKGROUND OF THE INVENTION

During installation of roofing materials (e.g., asphaltic shingles) on a roofing substrate, wind may affect the performance of the roofing material, in particular, during cold weather. In some examples, asphaltic sealants applied to the roofing material may not be activated during cold weather. There thus exists a need to enable the roofing material to be sealed or attached between roofing courses to prevent wind uplift, for example, during cold weather.

### SUMMARY OF THE INVENTION

One embodiment of this invention pertains to a method that comprises obtaining a first roofing material and a second roofing material, and obtaining a device. The device comprises a fastening mechanism configured to secure a roofing material to a roofing substrate and an adhesive mechanism configured to apply an adhesive to a surface of the roofing material. The fastening mechanism comprises a frame, a magazine of fasteners, and a trigger configured to advance a fastener from the magazine of fasteners into the roofing material. The adhesive mechanism comprises a container having a nozzle, wherein the container is configured to house the adhesive and the nozzle is configured to dispense the adhesive. The method further comprises positioning the first roofing material onto the roofing substrate, securing the first roofing material to the roofing substrate with the fastening mechanism, dispensing the adhesive from the adhesive mechanism onto the surface of the first roofing material, and contacting the second roofing material and the first roofing material such that the adhesive is between the second roofing material and the first roofing material.

In one embodiment, the adhesive contacts an area of the second roofing material that is free of (or does not interfere with) any existing (or pre-applied) sealant material on the second roofing material.

In one embodiment, the method further comprises securing the second roofing material to the roofing substrate with the fastening mechanism.

In one embodiment, the securing the second roofing material to the roofing substrate is conducted after contacting the second roofing material to the first roofing material.

In one embodiment, the securing the first roofing material to the roofing substrate with the fastening mechanism is conducted simultaneously with dispensing adhesive from the adhesive mechanism onto the surface of the first roofing material.

In one embodiment, the securing the first roofing material to the roofing substrate with the fastening mechanism is conducted by actuating the trigger to advance the fastener from the magazine through the first roofing material and into the roofing substrate thereby securing the first roofing material to the roofing substrate.

In one embodiment, the dispensing the adhesive from the adhesive mechanism onto the surface of the first roofing material is conducted by actuating the trigger to dispense the adhesive from the container through the nozzle and onto the surface of the first roofing material.

In one embodiment, the adhesive is dispensed from the adhesive mechanism at a different location than the fastener is advanced from the fastening mechanism.

In one embodiment, the adhesive mechanism comprises an attachment device for coupling the adhesive mechanism to the fastening mechanism.

In one embodiment, the method further comprises adjusting a position of the adhesive mechanism on the fastening mechanism.

In one embodiment, the adhesive mechanism is detachably coupled to the fastening mechanism.

In one embodiment, the adhesive mechanism is directly coupled to the fastening mechanism with the attachment device.

In one embodiment, the method further comprises removing the adhesive mechanism from the fastening mechanism and coupling a second adhesive mechanism to the fastening mechanism.

In one embodiment, the adhesive in the container of the adhesive mechanism has a different minimum activation temperature than an adhesive in a container of the second adhesive mechanism.

In one embodiment, each of the first roofing material and the second roofing material is one of (i) a single layer roofing shingle, (ii) a laminated roofing shingle having two or more layers, (iii) a roofing membrane, (iv) a roofing tile, or (v) a solar shingle.

In one embodiment, the roofing substrate comprises (i) a roof deck, (ii) roof underlayment, (iii) a roofing membrane, (iv) insulation, (v) a photovoltaic (PV) panel, or (vi) a combination of (i), (ii), (iii), (iv) and/or (v).

In one embodiment, the device is a handheld device.

In one embodiment, the device comprises a nail gun.

Another embodiment of this invention pertains to a method that comprises obtaining a first roofing material and a second roofing material, and obtaining a device. The device comprises a fastening mechanism configured to secure a roofing material to an underlying roofing material and an adhesive mechanism configured to apply an adhesive to a surface of the roofing material. The fastening mechanism comprises a frame, a magazine of fasteners, and a trigger configured to advance a fastener from the magazine of fasteners into the roofing material. The adhesive mechanism comprises a container having a nozzle, wherein the container is configured to house the adhesive and the nozzle is configured to dispense the adhesive. The method further comprises positioning the first roofing material onto the underlying roofing material, securing the first roofing material to the underlying roofing material with the fastening mechanism, dispensing the adhesive from the adhesive mechanism onto the surface of the first roofing material, and contacting the second roofing material and the first roofing material such that the adhesive is between the second roofing material and the first roofing material.

In one embodiment, the adhesive contacts an area of the second roofing material that is free of (or does not interfere with) any existing (or pre-applied) sealant material on the second roofing material.

In one embodiment, the method further comprises securing the second roofing material to the underlying roofing material with the fastening mechanism.

In one embodiment, the securing the second roofing material to the underlying roofing material is conducted after contacting the second roofing material to the first roofing material.

In one embodiment, the securing the first roofing material to the underlying roofing material with the fastening mechanism is conducted simultaneously with dispensing adhesive from the adhesive mechanism onto the surface of the first roofing material.

In one embodiment, the securing the first roofing material to the underlying roofing material with the fastening mechanism is conducted by actuating the trigger to advance the fastener from the magazine through the first roofing material and into the underlying roofing material thereby securing the first roofing material to the underlying roofing material.

In one embodiment, the dispensing the adhesive from the adhesive mechanism onto the surface of the first roofing material is conducted by actuating the trigger to dispense the adhesive from the container through the nozzle and onto the surface of the first roofing material.

In one embodiment, the adhesive is dispensed from the adhesive mechanism at a different location than the fastener is advanced from the fastening mechanism.

In one embodiment, the adhesive mechanism comprises an attachment device for coupling the adhesive mechanism to the fastening mechanism.

In one embodiment, the method further comprises adjusting a position of the adhesive mechanism on the fastening mechanism.

In one embodiment, the adhesive mechanism is detachably coupled to the fastening mechanism.

In one embodiment, the adhesive mechanism is directly coupled to the fastening mechanism with the attachment device.

In one embodiment, the method further comprises removing the adhesive mechanism from the fastening mechanism and coupling a second adhesive mechanism to the fastening mechanism.

In one embodiment, the adhesive in the container of the adhesive mechanism has a different minimum activation temperature than an adhesive in a container of the second adhesive mechanism.

In one embodiment, each of the first roofing material and the second roofing material is one of (i) a single layer roofing shingle, (ii) a laminated roofing shingle having two or more layers, (iii) a roofing membrane, (iv) a roofing tile, or (v) a solar shingle.

In one embodiment, the underlying roofing material comprises (i) a roof deck, (ii) roof underlayment, (iii) a roofing membrane, (iv) insulation, (v) a photovoltaic (PV) panel, (vi) a single layer roofing shingle, (vii) a laminated roofing shingle having two or more layers, (viii) a roofing tile, (ix) a solar shingle, or (x) a combination of (i), (ii), (iii), (iv), (v), (vi), (vii), (viii), and/or (ix).

In one embodiment, the device is a handheld device.

In one embodiment, the device comprises a nail gun.

Another embodiment of this invention pertains to a device comprising a fastening mechanism configured to secure a roofing material to (i) a roofing substrate and/or (ii) an underlying roofing material and an adhesive mechanism configured to apply an adhesive to a surface of the roofing material. The fastening mechanism comprises a frame, a magazine of fasteners, and a trigger configured to advance a fastener from the magazine of fasteners into the roofing material. The adhesive mechanism comprises a container having a nozzle, wherein the container is configured to house the adhesive and the nozzle is configured to dispense the adhesive. The device is configured to install a first roofing material and a second roofing material onto the roofing substrate and/or the underlying roofing material by fastening the first roofing material to the roofing substrate and/or the underlying roofing material with the fastening mechanism and adhering the second roofing material to the first roofing material with the adhesive mechanism.

In one embodiment, the trigger is configured to dispense the adhesive from the adhesive mechanism.

In one embodiment, the trigger is configured to dispense the adhesive from the adhesive mechanism simultaneously with advancing the fastener.

In one embodiment, the adhesive has a minimum activation temperature (tan &>1) below 70° F.

In one embodiment, the adhesive has a minimum activation temperature (tan &>1) below 40° F.

In one embodiment, the adhesive has a minimum activation temperature (tan &>1) of from 0° F. to 70° F.

In one embodiment, the adhesive has a minimum activation temperature (tan &>1) of from 0° F. to 40° F.

In one embodiment, the fastening mechanism is a component of a nail gun and the fastener may be a nail.

In one embodiment, the adhesive mechanism comprises an actuator configured to dispense the adhesive from the container, wherein the actuator is one of electrical, pneumatic, or mechanical.

In one embodiment, the device comprises a sensor, wherein at least one of the fastening mechanism or the adhesive mechanism is configured to be actuated upon a detecting of a surface of the roofing material with the sensor.

In one embodiment, the device is a handheld device.

In one embodiment, the device comprises a nail gun.

In one embodiment, the adhesive mechanism comprises an attachment device for coupling the adhesive mechanism to the fastening mechanism.

In one embodiment, the adhesive mechanism is one of a plurality of adhesive mechanisms, each of the plurality of adhesive mechanisms is configured to simultaneously be coupled to the fastening mechanism.

In one embodiment, the adhesive mechanism is one of a plurality of adhesive mechanisms, with a single adhesive mechanism being configured to be coupled to the fastening mechanism at a time, and all remaining adhesive mechanisms of the plurality of adhesive mechanisms being configured to be interchangeable with the single adhesive mechanism.

In one embodiment, the adhesive mechanism is directly coupled to the fastening mechanism with the attachment device.

In one embodiment, the adhesive mechanism is adjustably attached to the fastening mechanism, such that a position of the adhesive mechanism relative to the fastening mechanism is adjustable.

In one embodiment, the adhesive mechanism is detachably attached to the fastening mechanism.

In one embodiment, the attachment device comprises (i) a hook, (ii) a hook and loop fastener, (iii) an adhesive tape, (iv) straps, (v) fasteners, (vi) magnetic attachment, or (vii) a combination of (i), (ii), (iii), (iv), (v), and/or (vi).

In one embodiment, the adhesive mechanism comprises a heat generator coupled to the container and configured to maintain the adhesive above a predetermined temperature.

In one embodiment, the adhesive comprises (i) an asphaltic adhesive, (ii) a non-asphaltic adhesive, (iii) a solvent, (iv) an additive, (v) a two-part system that includes a curing agent, (vi) a foaming agent, or (vii) a combination of (i), (ii), (iii), (iv), (v) and/or (vi).

In one embodiment, the roofing material is one of (i) a single layer roofing shingle, (ii) a laminated roofing shingle having two or more layers, (iii) a roofing membrane, (iv) a roofing tile, or (v) a solar shingle.

In one embodiment, the roofing substrate is (i) a roof deck, (ii) roof underlayment, (iii) a roofing membrane, (iv) insulation, (v) a photovoltaic (PV) panel, or (vi) a combination of (i), (ii), (iii), (iv) and/or (v).

In one embodiment, the underlying roofing material comprises (i) a roof deck, (ii) roof underlayment, (iii) a roofing membrane, (iv) insulation, (v) a photovoltaic (PV) panel, (vi) a single layer roofing shingle, (vii) a laminated roofing shingle having two or more layers, (viii) a roofing tile, (ix) a solar shingle, or (x) a combination of (i), (ii), (iii), (iv), (v), (vi), (vii), (viii), and/or (ix).

Another embodiment of this invention pertains to a handheld device for installing a roofing material onto (i) a roofing substrate and/or (ii) an underlying roofing material that comprises a fastening mechanism configured to secure the roofing material to the roofing substrate and/or the underlying roofing material and an adhesive mechanism configured to apply an adhesive to a surface of the roofing material. The fastening mechanism comprises a frame, a magazine of fasteners, and a trigger configured to advance a fastener from the magazine of fasteners into the roofing material. The adhesive mechanism comprises a container configured to house the adhesive, the container having a nozzle and an attachment device for coupling the adhesive mechanism to the fastening mechanism. The trigger is configured to dispense the adhesive from the adhesive mechanism.

In one embodiment, the trigger is configured to dispense the adhesive from the adhesive mechanism simultaneously with advancing the fastener.

In one embodiment, the adhesive has a minimum activation temperature (tan &>1) below 70° F.

In one embodiment, the adhesive has a minimum activation temperature (tan &>1) below 40° F.

In one embodiment, the adhesive has a minimum activation temperature (tan &>1) of from 0° F. to 70° F.

In one embodiment, the adhesive has a minimum activation temperature (tan &>1) of from 0° F. to 40° F.

In one embodiment, the fastening mechanism is a component of a nail gun and the fastener may be a nail.

In one embodiment, the handheld device comprises a nail gun.

In one embodiment, the adhesive mechanism comprises an actuator configured to dispense the adhesive from the container, wherein the actuator may be one of electrical, pneumatic, or mechanical.

In one embodiment, the device comprises a sensor, wherein at least one of the fastening mechanism or the adhesive mechanism is configured to be actuated upon a detecting of a surface of the roofing material with the sensor.

In one embodiment, the adhesive mechanism is one of a plurality of adhesive mechanisms, each of the plurality of adhesive mechanisms is configured to simultaneously be coupled to the fastening mechanism.

In one embodiment, the adhesive mechanism is one of a plurality of adhesive mechanisms, with a single adhesive mechanism being configured to be coupled to the fastening mechanism at a time, and all remaining adhesive mechanisms of the plurality of adhesive mechanisms being configured to be interchangeable with the single adhesive mechanism.

In one embodiment, the adhesive mechanism is directly coupled to the fastening mechanism with the attachment device.

In one embodiment, the adhesive mechanism is adjustably attached to the fastening mechanism, such that a position of the adhesive mechanism relative to the fastening mechanism is adjustable.

In one embodiment, the adhesive mechanism is detachably attached to the fastening mechanism.

In one embodiment, the attachment device comprises (i) a hook, (ii) a hook and loop fastener, (iii) an adhesive tape, (iv) straps, (v) fasteners, (vi) magnetic attachment, or (vii) a combination of (i), (ii), (iii), (iv), (v), and/or (vi).

In one embodiment, the adhesive mechanism comprises a heat generator coupled to the container and configured to maintain the adhesive above a predetermined temperature.

In one embodiment, the adhesive comprises (i) an asphaltic adhesive, (ii) a non-asphaltic adhesive, (iii) a solvent, (iv) an additive, (v) a two-part system that includes a curing agent, (vi) a foaming agent, or (vii) a combination of (i), (ii), (iii), (iv), (v) and/or (vi).

In one embodiment, the roofing material is one of (i) a single layer roofing shingle, (ii) a laminated roofing shingle having two or more layers, (iii) a roofing membrane, (iv) a roofing tile, or (v) a solar shingle.

In one embodiment, the roofing substrate comprises (i) a roof deck, (ii) roof underlayment, (iii) a roofing membrane, (iv) insulation, (v) a photovoltaic (PV) panel, or (vi) a combination of (i), (ii), (iii), (iv) and/or (v).

In one embodiment, the underlying roofing material comprises (i) a roof deck, (ii) roof underlayment, (iii) a roofing membrane, (iv) insulation, (v) a photovoltaic (PV) panel, (vi) a single layer roofing shingle, (vii) a laminated roofing shingle having two or more layers, (viii) a roofing tile, (ix) a solar shingle, or (x) a combination of (i), (ii), (iii), (iv), (v), (vi), (vii), (viii), and/or (ix).

### BRIEF DESCRIPTION OF THE FIGURES

Features and advantages will be apparent from the following, more particular, description of various exemplary embodiments, as illustrated in the accompanying drawings, wherein like reference numbers generally indicate identical, functionally similar, and/or structurally similar elements.

FIG. 1 illustrates a schematic perspective view of a device for securing a roofing material to a roofing substrate, according to an embodiment of the invention.

FIG. 2 illustrates a roofing system, according to an embodiment of the invention.

FIG. 3 illustrates a schematic perspective view of another device for securing a roofing material to a roofing substrate, according to an embodiment of the invention.

FIG. 4 illustrates a schematic perspective view of another device for securing a roofing material to a roofing substrate, according to an embodiment of the invention.

### DETAILED DESCRIPTION OF THE INVENTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the meaning of “a,” “an,” and “the” include plural references. The meaning of “in” includes “in” and “on.”

As used herein, terms such as “comprising” “including,” and “having” do not limit the scope of a specific claim to the materials or steps recited by the claim.

As used herein, terms such as “consisting of”′ limit the scope of a specific claim to the materials and steps recited by the claim.

As used herein, the term “roofing substrate” comprises at least one of a plywood substrate, a glass substrate, a cellulosic substrate, a roof shingle, a glass mat, a fiberglass mat, roof underlayment, a roofing membrane, a roof deck, a photovoltaic (PV) panel, a modified bitumen (MODBIT) substrate, a roll good, a board (such as but not limited to at least one of a foam board (e.g., a polyisocyanurate (ISO) foam board), a cover board, or any combination thereof), insulation, a pipe, a base sheet, a chimney, a wax paper, or any combination thereof.

As used herein, the term “roofing material” refers to any material or component of a roof. In some embodiments, the roofing material comprises, consists of, or consists essentially of at least one of a roofing shingle (including, e.g., a single layer roofing shingle or a laminated roofing shingle having two or more layers), a roofing membrane, an underlayment, a roofing tile, a photovoltaic or a solar shingle, a roofing granule, a roof panel or panel roofing (e.g., metal panel roofing, steel panel roofing, alloy panel roofing, aluminum panel roofing, and the like), a non-asphaltic roofing shingle, a non-asphalt roof membrane, a polymeric roofing material, or any combination thereof.

As used herein, the term “activation temperature” refers to when an adhesive and/or a sealant exhibits a tan 8 value of greater than one (1) at a certain temperature, this indicates that the adhesive and/or sealant is activated and able to form a bond with a material (e.g., a roofing material) in contact with the adhesive and/or sealant.

This invention, in embodiments, relates to a device and method for securing a roofing material to a roofing substrate and/or an additional roofing material(s). The device and method of the present disclosure provide enhanced wind performance for roofing material (e.g., shingles) during cold weather installations. The device and method of the present disclosure allow for an installer-friendly, universal adhesive container that may be attached to a fastening device, such as a nail gun. The present invention, in embodiments, provides for enhanced wind performance of shingles, cold weather installation of shingles, attachments for nail guns, automatic adhesive ejection, and employing cold weather adhesives.

In some examples, dispensing of adhesive from the adhesive container is actuated by the nail gun operation during installation of the roofing material (e.g., the shingles) to eject small amounts of adhesive onto an already installed roofing material. The adhesive may have quick set or instant tack to form a bond between the shingle courses. In this manner, a second roofing material may be secured to the already installed roofing material with the adhesive. The adhesive tack allows for improved wind performance of the roofing material, without the need of the adhesive to achieve a certain temperature for curing. Once tacked to the already installed roofing material, the second roofing material may be secured to the roofing substrate and/or another underlying roofing material with a fastener (e.g., a nail) from the fastening device (e.g., a nail gun).

One embodiment of this invention pertains to a method that comprises obtaining a first roofing material and a second roofing material, and obtaining a device. The device comprises a fastening mechanism configured to secure a roofing material to a roofing substrate and an adhesive mechanism configured to apply an adhesive to a surface of the roofing material. The fastening mechanism comprises a frame, a magazine of fasteners, and a trigger configured to advance a fastener from the magazine of fasteners into the roofing material. The adhesive mechanism comprises a container having a nozzle, wherein the container is configured to house the adhesive and the nozzle is configured to dispense the adhesive. The method further comprises positioning the first roofing material onto the roofing substrate, securing the first roofing material to the roofing substrate with the fastening mechanism, dispensing the adhesive from the adhesive mechanism onto the surface of the first roofing material, and contacting the second roofing material and the first roofing material such that the adhesive is between the second roofing material and the first roofing material.

Another embodiment of this invention pertains to a method that comprises obtaining a first roofing material and a second roofing material, and obtaining a device. The device comprises a fastening mechanism configured to secure a roofing material to an underlying roofing material and an adhesive mechanism configured to apply an adhesive to a surface of the roofing material. The fastening mechanism comprises a frame, a magazine of fasteners, and a trigger configured to advance a fastener from the magazine of fasteners into the roofing material. The adhesive mechanism comprises a container having a nozzle, wherein the container is configured to house the adhesive and the nozzle is configured to dispense the adhesive. The method further comprises positioning the first roofing material onto the underlying roofing material, securing the first roofing material to the underlying roofing material with the fastening mechanism, dispensing the adhesive from the adhesive mechanism onto the surface of the first roofing material, and contacting the second roofing material and the first roofing material such that the adhesive is between the second roofing material and the first roofing material.

In one embodiment, the adhesive contacts an area of the second roofing material that is free of (or does not interfere with) any existing (or pre-applied) sealant material on the second roofing material.

Another embodiment of this invention pertains to a device comprising a fastening mechanism configured to secure a roofing material to (i) a roofing substrate and/or (ii) an underlying roofing material and an adhesive mechanism configured to apply an adhesive to a surface of the roofing material. The fastening mechanism comprises a frame, a magazine of fasteners, and a trigger configured to advance a fastener from the magazine of fasteners into the roofing material. The adhesive mechanism comprises a container having a nozzle, wherein the container is configured to house the adhesive and the nozzle is configured to dispense the adhesive. The device is configured to install a first roofing material and a second roofing material onto the roofing substrate and/or the underlying roofing material by fastening the first roofing material to the roofing substrate and/or the underlying roofing material with the fastening mechanism and adhering the second roofing material to the first roofing material with the adhesive mechanism.

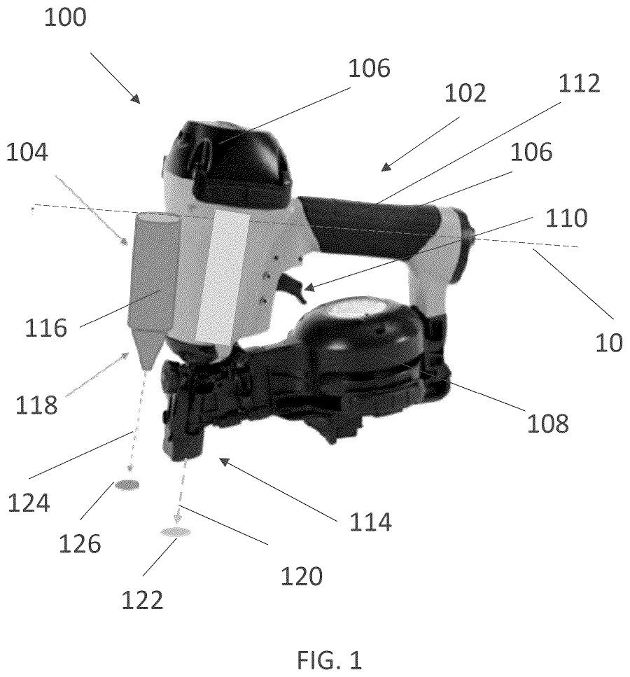

FIG. 1 illustrates an exemplary device 100 for securing a roofing material (e.g., a shingle) to a roofing substrate and/or the underlying roofing material. The device 100 includes a fastening mechanism 102 and an adhesive mechanism 104.

The fastening mechanism 102 includes a frame 106, a magazine of fasteners 108, and a trigger 110. The frame 106 includes a handle 112 such that, according to one embodiment, the device 100 is a handheld device, such as, e.g., a nail gun. The magazine of fasteners 108 includes one or more fasteners (not visible) that may be dispensed through an opening 114 from the magazine of fasteners 108 upon actuation of the trigger 110.

The adhesive mechanism 104 includes a container 116, also referred to herein as a canister or cartridge, and a nozzle 118 at a distal end of the container 116. The container 116 may house an adhesive. When the adhesive mechanism 104 is actuated, the adhesive may be dispensed from the container 116 through the nozzle 118. The adhesive mechanism may be actuated with the trigger 110 or with a different actuator. The actuator or trigger may be electrical, pneumatic, mechanical, or combinations thereof. The adhesive mechanism 104 may include a heat generator (not shown) coupled to the container for maintaining the adhesive above a predetermined temperature (e.g., to keep the adhesive warm).

In some examples, the adhesive mechanism 104 includes an attachment device (not visible) for coupling the adhesive mechanism 104 to fastening mechanism 102. In some examples, the adhesive mechanism 104 is directly coupled to the fastening mechanism 102 with the attachment device. The attachment device may be a hook, a hook and loop fastener, an adhesive tape, one or more straps, one or more fasteners, peel and stick tape, screws, a VELCRO® mechanism, magnetic attachment, or any combination thereof. The attachment device is engineered to fit the nail gun, straps, or combinations thereof. In some examples, the attachment between the adhesive mechanism 104 and the fastening mechanism 102 is permanent. In some examples, the attachment is removable or detachable. In such examples, the container 116 may be removed and replaced, exchanged, or interchanged with the same container or a different container. For example, when the container 116 is empty or when a different roofing or weather condition is encountered, the container 116 may be removed to refill the adhesive, to replace with a different adhesive (either in the same or different container), to repair the adhesive mechanism 104, etc. In some examples, the adhesive may be replaced in order to allow for employment of adhesives having different minimum activation temperatures. The adhesive may be suitable for temperatures of 70° F. or below, have a suitable period of setting to allow for repositioning of the roofing material, and will not damage the roofing material for their long term durability.

Although a single adhesive mechanism 104 with a single container 116 is illustrated in FIG. 1, more may be provided. In some examples, more than one container 116 may be attached to the device 100 at the same time. In such examples, the multiple containers 116 may be spaced between 0.5 inches and 2 inches apart. Including multiple containers 116 with nozzles 118 allows for application of adhesive in more linear points. In some examples, each container 116 may include multiple dispenser nozzles (e.g., nozzles 118) to allow for adhesive application in more linear points.

During operation of the device 100, the trigger 110 is actuated to dispense one or more fasteners from the magazine of fasteners 108. The fasteners may be, for example, nails, screws, bolts, pins, or the like. The trigger 110 may also dispense the adhesive from the container 116. For example, upon actuation of the trigger 110, the device 100 may dispense both a fastener and adhesive, either simultaneously or sequentially. In some examples, the trigger 110 may be actuated multiple times such that on a first actuation, the fastener is dispensed and on a second actuation, sequentially following the first actuation, the adhesive is dispensed. In some examples, the adhesive mechanism 104 includes a separate activation mechanism that is not the trigger 110. The separate activation mechanism may be an adhesive trigger.

As illustrated in FIG. 1, the fastener is dispensed from an opening 114 and the adhesive is dispensed from the nozzle 118. The fastener (not visible) has a path of travel 120 to an installation location 122. The adhesive (not visible) has a path of travel 124 to an installation location 126. In the example of FIG. 1, the path of travel 120 and the path of travel 124 are parallel and offset. The adhesive is dispensed at an installation location 126 that is axially forward, with respect to a longitudinal axis 10, of the installation location 122 of the fastener.

The device 100 may include a sensor (not shown). The fastening mechanism 102, the adhesive mechanism 104, or both, may be actuated upon detecting a surface of the roofing material, the roofing substrate, or an underlying roofing material with the sensor.

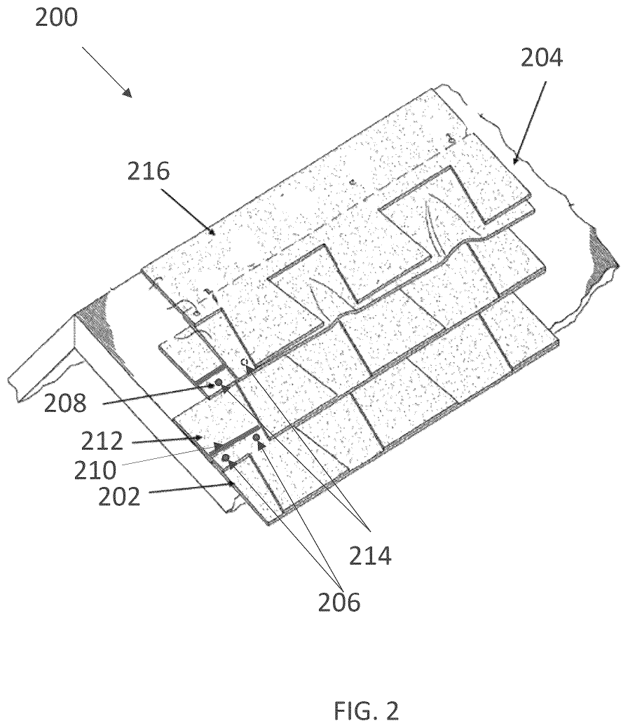

The device 100 may be employed to install a roofing material (e.g., a shingle) on a roofing substrate and/or an underlying roofing material. For example, FIG. 2 illustrates a roofing system 200 that employed the device 100 of FIG. 1. In FIG. 2, a first roofing material 202 may be secured to the roofing substrate 204 with one or more fasteners 206. The one or more fasteners 206 may be advanced from the magazine of the device 100 with the trigger of the device 100. When a second roofing material 208 is to be added in an overlapping manner to the first roofing material 202 (as is known in the art with respect to shingles, for example), the device 100 is actuated to dispense an adhesive 210 from the adhesive mechanism 104 onto a portion of a top, exposed surface 212 of the first roofing material 202. A back surface (not visible) of the second roofing material 208 is then contacted to the top surface 212 of the first roofing material 202 such that the adhesive 210 is located between the back surface of the second roofing material 208 and the top surface 212 of the first roofing material 202. The adhesive 210 holds the second roofing material 208 onto the first roofing material 202. When only the adhesive 210 is securing the second roofing material 208 to the first roofing material 202, the adhesive 210 allows for improved wind resistance and works to prevent the second roofing material 208 from being removed from the first roofing material 202. After securing the second roofing material 208 to the first roofing material 202 with the adhesive 210, the fastening mechanism 102 may actuated to dispense one or more fasteners 214 into the second roofing material 208 to secure the second roofing material 208 to the roofing substrate 204. The process may be continued as needed to install additional roofing material (e.g., roofing material 216 in a vertically adjacent course or additional roofing material in the same course as the first roofing material 202 and/or the second roofing material 208) on the roofing substrate 204.

As illustrated in FIG. 2, the fastener 206 may be dispensed at a different location than the adhesive 210. In other examples, the location may be the same.

Although FIG. 2 illustrates a single roofing material in each vertical course, more may be provided. Additionally, although 3 vertically adjacent courses are illustrated, more may be provided. FIG. 2 illustrates the one or more fasteners and the adhesive in a central region of each roofing substrate and/or roofing material, however, other locations are contemplated. For example, the fasteners and adhesive may be applied in a vertically upper region of each roofing material.

In some examples, the adhesive is dispensed on the first roofing material simultaneously with the fastener being installed to secure the first roofing material, and likewise for the remaining roofing material. In some examples, the adhesive is dispensed on the first roofing material after the fastener is installed in the first roofing material, and likewise for the remaining roofing material.

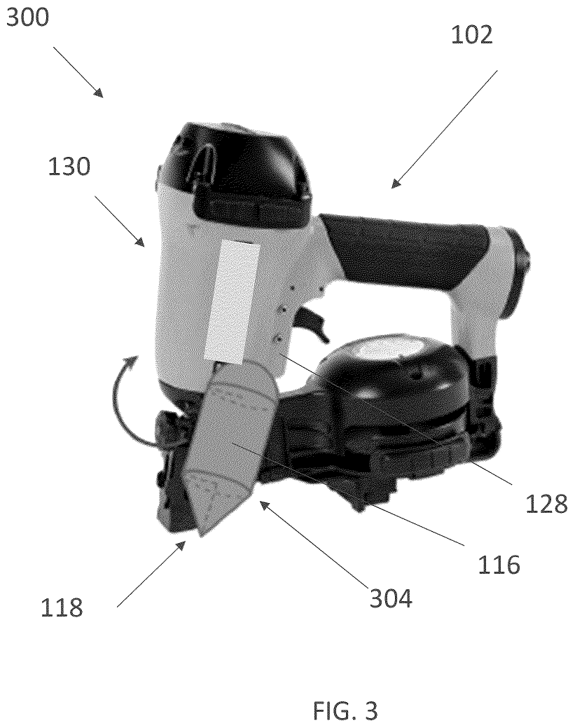

FIG. 3 illustrates another exemplary device 300 for securing a roofing material to a roofing substrate and/or an underlying roofing material. The device 300 is substantially similar to the device 100 described with respect to FIG. 1, except as described to follow. Accordingly, the same reference numerals will be used for components of the device 300 that are the same as or similar to the components of the device 100 discussed above. The description of these components above also applies to this embodiment, and a detailed description of these components is omitted here.

The device 300 includes the fastening mechanism 102 and an adhesive mechanism 304. As noted, the fastening mechanism 102 is the same as the fastening mechanism 102 described with respect to FIG. 1. The adhesive mechanism 304 includes the container 116 and the nozzle 118 described with respect to FIG. 1. The variations described with respect to the container 116 and the nozzle 118 apply to FIG. 3 as well.

The adhesive mechanism 304 is attached to a side surface of the fastening mechanism 102. That is, instead of being attached to a forward surface (as in FIG. 1), the adhesive mechanism 304 may be attached to a first side surface 128 or a second side surface 130 (opposing the first side surface 128). Although not illustrated, the adhesive mechanism 304 may be coupled to a rear side (opposing the forward side of FIG. 1) of the fastening mechanism 102.

In the example of FIG. 3, the adhesive mechanism 304 may be rotatable or adjustable such that the adhesive mechanism 304 may be moved between the position shown in FIG. 3 and another position, such as a position 180 degrees apart, on the opposing side (e.g., the second side surface 130) of the fastening mechanism 102. This allows for multiple handling orientations and more control of where the adhesive is dispensed on the roofing material.

Operation of the adhesive mechanism 304 may be the same as described with respect to FIG. 1. The path of travel of the adhesive (not visible) and the fastener (not visible) may be parallel and offset, as in FIG. 1. In FIG. 3, however, the path of travel of the adhesive is offset laterally from the path of travel of the fastener, not forward of, as described with respect to FIG. 1.

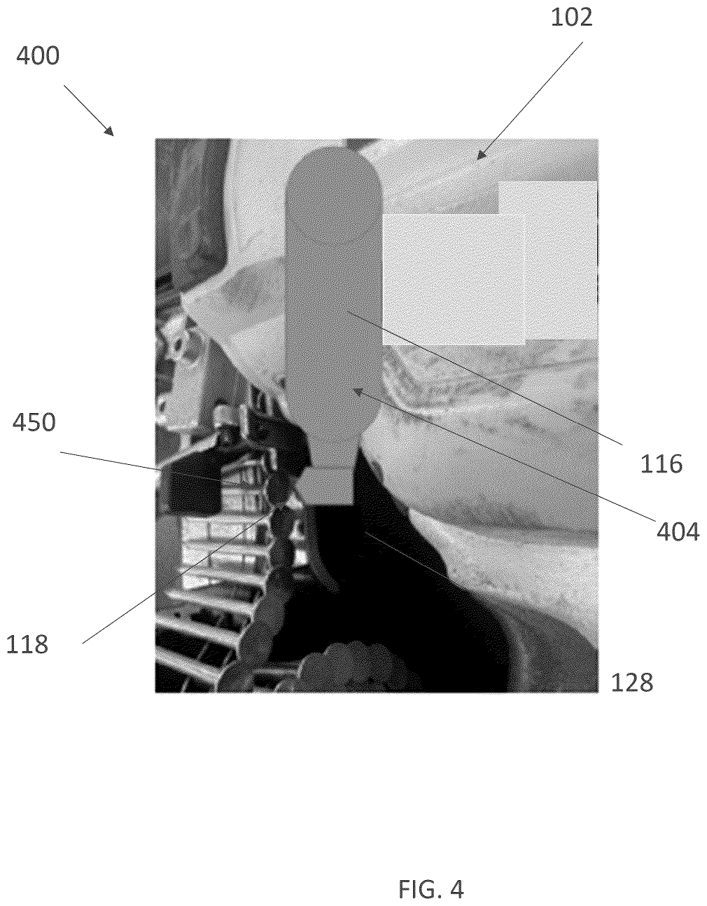

FIG. 4 illustrates a close up of a portion of an exemplary device 400 for securing a roofing material to a roofing substrate. The device 400 is substantially similar to the device 100 described with respect to FIG. 1, except as described to follow. Accordingly, the same reference numerals will be used for components of the device 400 that are the same as or similar to the components of the device 100 discussed above. The description of these components above also applies to this embodiment, and a detailed description of these components is omitted here.

The device 400 includes the fastening mechanism 102 and an adhesive mechanism 404. As noted, the fastening mechanism 102 is the same as the fastening mechanism 102 described with respect to FIG. 1. The adhesive mechanism 404 includes the container 116 and the nozzle 118 described with respect to FIG. 1. The variations described with respect to the container 116 and the nozzle 118 apply to FIG. 4 as well.

The adhesive mechanism 404 is attached to a side surface of the fastening mechanism 102. The nozzle 118 is perpendicular to the longitudinal axis of the container 116 as is aligned with a head of a fastener 450. When dispensed, the adhesive exits the nozzle 118 and is deposited on the head of the fastener 450 prior to installation on roofing material.

Stated another way, the mounting method of the adhesive dispensing device, also referred to as the adhesive mechanism 404, can be strapped around any side of the fastening mechanism 102 (e.g., nail gun). The body that is being strapped to the fastening mechanism 102 is referred to as the cartridge or hopper. The nozzle 118 of the adhesive mechanism 404 is placed between the gun and the nails. The adhesive mechanism 404 is activated by the switch or trigger 110 (FIG. 1) which dispenses a small dot of adhesive onto a fresh nail head in the adhesive's path. That nail with a small dot of adhesive on the nail head will resume up the nail gun and be driven with a modified nonstick driver into the roofing material.

Operation of the adhesive mechanism 404 is substantially the same as described with respect to FIG. 1. In FIG. 4, however, when the adhesive is dispensed from the adhesive mechanism 404, the adhesive is dispensed onto the fastener head prior to installation of the fastener. Thus, when the fastening mechanism 102 is activated to secure the roofing material, the adhesive is already applied to the fastener. Once the fastener is installed in the first roofing material, the second roofing material may be contacted with the first roofing material to secure thereto. The application of the adhesive to the fastener head may occur simultaneously with the dispensing of the fastener or prior to the dispensing of the fastener.

In an embodiment, the roofing material is a single layer roofing shingle or a laminated roofing shingle having two or more layers, or combinations thereof. In another embodiment, the roofing material is one of (i) a single layer roofing shingle, (ii) a laminated roofing shingle having two or more layers, (iii) a roofing membrane, (iv) a roofing tile, or (v) a solar shingle.

In an embodiment, the roofing material is configured to attach to a roofing substrate and/or an underlying roofing material via one or more fasteners. The fasteners may include, for example, nails, screws, staples, anchors, bolts, hardware, nuts, pins, studs, clips, rivets, rods, sockets, retaining rings, clamps, clasps, hangers, latches, pegs, washers, sealants, adhesives, etc., or combinations thereof.

In an embodiment, the roofing substrate comprises a roof deck, roof underlayment, a roofing membrane, insulation, a photovoltaic (PV) panel, or combinations thereof.

In one embodiment, the underlying roofing material comprises a roof deck, roof underlayment, a roofing membrane, insulation, a photovoltaic (PV) panel, a single layer roofing shingle, a laminated roofing shingle having two or more layers, a roofing tile, a solar shingle, or combinations thereof.

In an embodiment, the adhesive is an asphaltic adhesive, a non-asphaltic adhesive, a solvent, an additive, a two-part system that includes a curing agent, a foaming agent, or any combination thereof.

In one embodiment, the adhesive has a minimum activation temperature (tan &>1) below 70° F. In one embodiment, the adhesive has a minimum activation temperature (tan 8>1) below 40° F. In one embodiment, the adhesive has a minimum activation temperature (tan &>1) of from 0° F. to 70° F. In one embodiment, the adhesive has a minimum activation temperature (tan 8>1) of from 0° F. to 40° F.

According to one embodiment, the device of the present disclosure provides enhanced wind performance of roofing materials being installed in cold weather, which may result in an extended roofing season. For example, the wind performance of a shingle installed during cold weather where the air temperatures are 50° F. or lower can be improved by adhesives that are released from a small container or canister attached to the nail gun or fastening mechanism. In this manner, the adhesives may be released by a mechanism triggered during nail gun operation. This provides a quick tack or bond between shingle courses thereby enhancing their wind performance.

In some embodiments, the device is a nail gun and/or is easily attached to a nail gun used by roofers, such that the device may be added to the nail gun during shingle installation in cold weather and be taken off thereafter or when not employed.

In some embodiments, the adhesive containers or canisters may be exchanged when empty or for different roofing conditions. For example, there may exist an adhesive cartridge designed for cold weather installation and an adhesive cartridge for shingle installation at warm weather in preparation for imminent storms. The device may have a dispenser for the adhesives that may eject small amounts of the adhesives when activated by the nail gun operations. The container may be easily changed during shingle installation. The container may be designated for different installation conditions or temperatures for wind performance.

In some embodiments, the dispensing of the adhesive may be operated by battery power or by mechanical means to eject the adhesives. The dispensing may be activated by the nail gun trigger when the roofer fires the nail gun, or by the pressing of the nail gun head against the shingle surface, or by a sensor that senses the presence of the shingle surface when the nail gun is ready to be fired, or by any combination thereof.

In some examples, the adhesives may be asphaltic-based where it has the desirable viscosity to flow at low temperatures such as 40° F. or below and may be cured at the installation temperature within a reasonable time period. This may be achieved by modifying the asphaltic sealant materials by solvents or low-Tg additives. The adhesives may be non-asphaltic systems that provide the same performance described herein. Furthermore, the adhesives may be a 2-part system where a quick-setting mechanism may be set up by the addition of a curing agent upon the mixing of the two components at the point of ejection. This is beneficial since the set time may be adjusted by the amount of curing agent to achieve a desirable working period for repositioning of the roofing material, or for desirable temperatures. Furthermore, this may be able to extend the life of the adhesive container since the adhesives can remain fluid for a prolonged period prior to ejection. The adhesive does not damage the roofing material or negatively impact the long term durability of the roofing material.

Asphaltic shingles are known to have issues with wind performance when installed during cold weather, such as those installed in air temperature of 50° F. or below. This is due to the fact that the asphaltic sealants of the said shingles are not tacky and will not be activated until the shingles reach a higher temperature of 80° F. or above. As a result, shingles installed during the colder months of November through March in the northern regions can be damaged by wind since these shingles do not have a sealant that can be activated to resist the wind uplift. Accordingly, the present invention provides a universal apparatus and method of enhancing shingle wind performance during cold weather installations. For example, the present invention provides an installer-friendly, universal adhesive canister that can be easily attached to a nail gun and can be activated by nail gun operation during shingle installation to eject out small amounts of adhesives, such that shingles can have instant tack during installation for improved wind performance, without the need for shingles to reach certain temperatures for curing their sealants. Thus, the present invention may extend the roofing seasons for contractors. The present invention fills the need of enabling shingles to be sealed or attached between courses to prevent wind uplift when installed in cold weather.

Although the invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. A method comprising:
obtaining a first roofing material and a second roofing material;
obtaining a device comprising:
a fastening mechanism configured to secure a roofing material to a roofing substrate, the fastening mechanism comprising:
a frame;
a magazine of fasteners; and
a trigger configured to advance a fastener from the magazine of fasteners into the roofing material; and
an adhesive mechanism configured to apply an adhesive to a surface of the roofing material, the adhesive mechanism comprising a container having a nozzle, wherein the container is configured to house the adhesive and the nozzle is configured to dispense the adhesive;
positioning the first roofing material onto the roofing substrate;
securing the first roofing material to the roofing substrate with the fastening mechanism;
dispensing the adhesive from the adhesive mechanism onto the surface of the first roofing material; and
contacting the second roofing material and the first roofing material such that the adhesive is between the second roofing material and the first roofing material.

2. The method of claim 1, further comprising securing the second roofing material to the roofing substrate with the fastening mechanism.

3. The method of claim 2, wherein the securing the second roofing material to the roofing substrate is conducted after contacting the second roofing material to the first roofing material.

4. The method of claim 1, wherein the securing the first roofing material to the roofing substrate with the fastening mechanism is conducted simultaneously with dispensing adhesive from the adhesive mechanism onto the surface of the first roofing material.

5. The method of claim 1, wherein the securing the first roofing material to the roofing substrate with the fastening mechanism is conducted by actuating the trigger to advance the fastener from the magazine through the first roofing material and into the roofing substrate thereby securing the first roofing material to the roofing substrate.

6. The method of claim 1, wherein the dispensing the adhesive from the adhesive mechanism onto the surface of the first roofing material is conducted by actuating the trigger to dispense the adhesive from the container through the nozzle and onto the surface of the first roofing material.

7. The method of claim 1, wherein each of the first roofing material and the second roofing material is one of (i) a single layer roofing shingle, (ii) a laminated roofing shingle having two or more layers, (iii) a roofing membrane, (iv) a roofing tile, or (v) a solar shingle.

8. The method of claim 1, wherein the roofing substrate comprises (i) a roof deck, (ii) roof underlayment, (iii) a roofing membrane, (iv) insulation, (v) a photovoltaic (PV) panel, or (vi) a combination of (i), (ii), (iii), (iv) and/or (v).

9. A device comprising:
a fastening mechanism configured to secure a roofing material to a roofing substrate or an underlying roofing material, the fastening mechanism comprising:
a frame;
a magazine of fasteners; and
a trigger configured to advance a fastener from the magazine of fasteners into the roofing material; and
an adhesive mechanism configured to apply an adhesive to a surface of the roofing material, the adhesive mechanism comprising a container having a nozzle, wherein the container is configured to house the adhesive and the nozzle is configured to dispense the adhesive,
wherein the device is configured to install a first roofing material and a second roofing material onto the roofing substrate or the underlying roofing material by fastening the first roofing material to the roofing substrate or the underlying roofing material with the fastening mechanism and adhering the second roofing material to the first roofing material with the adhesive mechanism.

10. The device of claim 9, wherein the trigger is configured to dispense the adhesive from the adhesive mechanism.

11. The device of claim 9, wherein the trigger is configured to dispense the adhesive from the adhesive mechanism simultaneously with advancing the fastener.

12. The device of claim 9, wherein the adhesive mechanism comprises an actuator configured to dispense the adhesive from the container, wherein the actuator is one of electrical, pneumatic, or mechanical.

13. The device of claim 9, wherein the device further comprises a sensor, and wherein at least one of the fastening mechanism or the adhesive mechanism is configured to be actuated upon a detecting of a surface of the roofing material with the sensor.

14. The device of claim 9, wherein the adhesive mechanism comprises an attachment device for coupling the adhesive mechanism to the fastening mechanism.

15. The device of claim 14, wherein the adhesive mechanism is detachably attached to the fastening mechanism.

16. The device of claim 9, wherein the adhesive mechanism comprises a heat generator coupled to the container and configured to maintain the adhesive above a predetermined temperature.

17. A handheld device for installing a roofing material onto a roofing substrate or an underlying roofing material, the handheld device comprising:
a fastening mechanism configured to secure the roofing material to the roofing substrate or the underlying roofing material, the fastening mechanism comprising:
a frame;
a magazine of fasteners; and
a trigger configured to advance a fastener from the magazine of fasteners into the roofing material; and
an adhesive mechanism configured to apply an adhesive to a surface of the roofing material, the adhesive mechanism comprising:
a container configured to house the adhesive, the container having a nozzle; and
an attachment device for coupling the adhesive mechanism to the fastening mechanism,
wherein the trigger is configured to dispense the adhesive from the adhesive mechanism.

18. The handheld device of claim 17, wherein the trigger is configured to dispense the adhesive from the adhesive mechanism simultaneously with advancing the fastener.

19. The handheld device of claim 17, wherein the adhesive mechanism is adjustably attached to the fastening mechanism, such that a position of the adhesive mechanism relative to the fastening mechanism is adjustable.

20. The handheld device of claim 17, wherein the attachment device comprises (i) a hook, (ii) a hook and loop fastener, (iii) an adhesive tape, (iv) straps, (v) fasteners, or (vi) a combination of (i), (ii), (iii), (iv), and/or (v).
